(19) United States
(12) Patent Application Publication
(10) Pub. No.: US 2024/0004114 A1
(43) Pub. Date: Jan. 4, 2024

(54) SYSTEM AND METHOD TO PREVENT UNINTENDED VIEWING OF A PROJECTED IMAGE

(71) Applicant: SOLUTIA INC., ST. LOUIS, MO (US)

(72) Inventors: JAIME ANTONIO LI, MARTINSVILLE, VA (US); CASEY LYNN ELKINS, KINGSPORT, TN (US); STEVEN V. HALDEMAN, HAMPDEN, MA (US); FRANCOIS ANDRE KORAN, LONGMEADOW, MA (US)

(73) Assignee: SOLUTIA INC., ST. LOUIS, MO (US)

(21) Appl. No.: 18/255,614

(22) PCT Filed: Dec. 2, 2021
(86) PCT No.: PCT/US2021/061516

§ 371 Date: Jun. 2, 2023

Related U.S. Application Data
(60) Provisional application No. 63/121,310, filed on Dec. 4, 2020.

(51) Int. Cl. G02B 5/22; G03B 21/14

(52) U.S. Cl. CPC G02B 5/223; G03B 21/14

(57) ABSTRACT

Display systems and methods are disclosed for displaying images, while preventing or reducing unintended viewing. A projector is provided that emits light toward a viewing surface at three discrete wavelength ranges to create an image. A light-absorbing substrate is also provided, disposed between the viewing surface and the unintended viewer, incorporating narrow-band absorbers that selectively absorb light within the three wavelength ranges, thus reducing or eliminating the image perceived by the unintended viewer.

### FIELD OF THE INVENTION

The present invention is generally directed to systems and methods to prevent unintended or unwanted viewing of projected images.

### BACKGROUND OF THE INVENTION

Light projectors have been used for decades to project still or moving images onto a surface such as a projector screen. While traditional projectors create this image by projecting a light through a lens, newer projectors such as laser and LED projectors may project the image directly onto the projector screen. Thus, in a modern iteration, a projection system may comprise a computerized signal generator, an LED or laser projector, and a surface such as a projection screen. The images generated by the computerized signal generator are fed to the projector, which generates light patterns that appear as the intended image on the projector screen. The image travels to the intended viewer's pupils in the form of visual information.

However, this image may also be viewed by unintended viewers, for example those in an adjacent room who can view the image through a window or other opening. Alternatively, there may be someone in the same room in which the image is being projected, for example a worker performing various tasks requiring concentration, for whom the image is simply an unwanted distraction. It would be an advantage to provide a means for preventing or reducing unintended or unwanted viewing of an image from a projector, while allowing intended and desired viewing of the image by intended viewers.

U.S. Pat. No. 7,777,960 discloses a projection system, such as a system suitable for head-up displays in automobiles, that includes a laser projection source and a scanner. Light from the laser projection source is scanned across a projection surface, which can be a car's windshield. The projection surface includes a buried numerical aperture expander capable of reflecting some light and transmitting other light. The system may also include an image projection source capable of presenting high-resolution images on a sub-region of the projection surface that has an optical relay disposed therein.

EP2045647A1 discloses a multi-colored head-up-display for use in motor vehicles for combining driver information with the scene in front of the vehicle. The display has a projection unit with a combiner unit, that exhibits anti-reflection coating at a side turned away from the viewer. An image sensor is provided that has a light source that emits light in three color bands. The combiner unit exhibits a triple-notch-filter at a side turned toward a viewer.

U.S. Pat. Appln. Publn. No. 2018/0031749 discloses a metamaterial optical filter including: a transparent substrate; and a photosensitive polymer layer provided to the transparent substrate, wherein the photosensitive polymer layer is treated using a laser to form a non-conformal holographically patterned subwavelength grating, the holographic grating configured to block a predetermined wavelength of electromagnetic radiation.

U.S. Pat. Appln. Publn. No. 2018/0186125 discloses a laminate that utilizes the ability of a narrow band absorbing dyes to absorb selective wavelengths of light by identifying a color target and tuning to that target. Working with just glass compositions, coatings, interlayers and films, all of which act as broad band filters, it is said to be difficult to fine tune the spectral response of a laminate. Narrow band absorbing dyes are used to selectively tune the spectral response to achieve targeted performance in the UV, visible and IR ranges of the spectrum.

A continuing need exists for preventing or reducing unintended or unwanted viewing of an image from a projector, while allowing intended and desired viewing of the image by those for whom the image was intended.

### SUMMARY OF THE INVENTION

In one aspect, the present invention relates to a display system for displaying an image, the display system provided with a projector that emits light toward a viewing surface at three discrete wavelength ranges to create an image. The display system is further provided with a viewing surface that allows viewing of the image by both an intended viewer and an unintended viewer. The system further provides a light-absorbing substrate, disposed between the viewing surface and the unintended viewer, incorporating one or more narrow-band absorbers that selectively absorb light within the three discrete wavelength ranges, thus reducing or eliminating the image perceived by the unintended viewer.

In another aspect, the invention relates to methods for preventing unintended viewing of an image on a viewing surface, the image formed from light from a projector emitted at three discrete wavelength ranges. In this aspect, the inventive methods comprise placing a light-absorbing substrate between the viewing surface and the unintended viewer, that incorporates one or more narrow-band absorbers that selectively absorb light within the three discrete wavelength ranges, thus reducing or eliminating the image perceived by the unintended viewer.

Further aspects of the invention are as disclosed and claimed herein.

### BRIEF DESCRIPTION OF THE DRAWINGS

FIG. 1 is a simple schematic of a system according to one embodiment of the invention.

FIG. 2 is a simple schematic of a system according to one embodiment of the invention.

### DETAILED DESCRIPTION

The present invention is thus directed to a display system for displaying an image. In one aspect, the display system comprises a projector that emits light toward a viewing surface at three discrete wavelength ranges to create an image. In other aspects, the projector may emit light at three or more discrete wavelength ranges, or at exactly three discrete wavelength ranges. The viewing surface is one that allows viewing of the image by both an intended viewer and an unintended viewer. The display system is further provided with a light absorbing substrate, disposed or positioned between the viewing surface and the unintended viewer, that incorporates one or more narrow-band absorbers that selectively absorb light within the wavelength ranges, thus reducing or eliminating the image perceived by the unintended viewer.

In another aspect, the invention relates to methods of preventing unintended viewing of an image on a viewing surface, the image formed from light from a projector emitted at three discrete wavelength ranges. In this aspect, the inventive methods comprise placing a light-absorbing substrate between the viewing surface and the unintended viewer, that incorporates one or more narrow-band absorbers that selectively absorb light within the three discrete wavelength ranges, thus reducing or eliminating the image perceived by the unintended viewer.

In one embodiment, the invention thus relates to display systems for displaying an image, the systems comprising a projector that emits light toward a viewing surface at three discrete wavelength ranges in the visible spectrum to create an image. The systems further comprise a viewing surface that allows viewing of the image by both an intended viewer and an unintended viewer; and a light-absorbing substrate, disposed between the viewing surface and the unintended viewer, incorporating one or more narrow-band absorbers that selectively absorb light within the three discrete wavelength ranges, thus reducing or eliminating the image perceived by the unintended viewer.

In a second embodiment, according to the first embodiment, the discrete wavelength ranges emitted by the projector include light of 445 nm, 515 nm, and 642 nm.

In a third embodiment, according to any of the preceding embodiments, the three discrete wavelength ranges emitted by the projector include light of 445 nm, 550 nm, and 642 nm.

In a fourth embodiment, according to any of the preceding embodiments, one of the discrete wavelength ranges emitted by the projector includes light having a wavelength selected from one or more of 635, 638, 650, or 660.

In a fifth embodiment, according to any of the preceding embodiments, the one or more narrow band absorbers exhibit a FWHM from about 0.5 nm to about 100 nm.

In a sixth embodiment, according to any of the preceding embodiments, the projector is selected from a laser diode-based projector, a DPSS laser-based projector, an LED projector, a hybrid laser-LED projector, or a wave guide projector.

In a seventh embodiment, according to any of the preceding embodiments, the narrow-band absorbers are selected from dyes and pigments.

In an eighth embodiment, according to any of the preceding embodiments, at least one of the narrow-band absorbers is a polymethine dye.

In a ninth embodiment, according to any of the preceding embodiments, the light absorbing substrate comprises a window.

In a tenth embodiment, according to any of the preceding embodiments, the window comprises a transparent polymeric substrate.

In an eleventh embodiment, according to any of the preceding embodiments, the light absorbing substrate is a window film applied to a window.

In a twelfth embodiment, according to any of the preceding embodiments, the light absorbing substrate comprises a pair of eyeglass lenses worn by the unintended viewer.

In a thirteenth embodiment, according to any of the preceding embodiments, the light absorbing substrate further comprises a UV absorber.

In a fourteenth embodiment, according to any of the preceding embodiments, the light-absorbing substrate further comprises a near infrared absorber.

In a first method embodiment, the invention relates to methods of preventing unintended viewing of an image on a viewing surface, the image formed from light from a projector emitted at three discrete wavelength ranges. In this embodiment, the methods compris placing a light-absorbing substrate between the viewing surface and the unintended viewer, that incorporates one or more narrow-band absorbers that selectively absorb light within the three discrete wavelength ranges, thus reducing or eliminating the image perceived by the unintended viewer.

In a second method embodiment, according to the first method embodiment, the three discrete wavelength ranges emitted by the projector include light of 445 nm, 515 nm, and 642 nm.

In a third method embodiment, according to any of the preceding method embodiments, the three discrete wavelength ranges emitted by the projector include light of 445 nm, 550 nm, and 642 nm.

In a fourth method embodiment, according to any of the preceding method embodiments, one of the discrete wavelength ranges emitted by the projector includes light having a wavelength selected from one or more of 635, 638, 650, or 660.

In a fifth method embodiment, according to any of the preceding method embodiments, the projector is selected from a laser diode-based projector, a DPSS laser-based projector, an LED projector, a hybrid laser-LED projector, or a wave guide projector.

In a sixth method embodiment, according to any of the preceding method embodiments, the narrow-band absorbers are selected from dyes and pigments.

In a seventh method embodiment, according to any of the preceding method embodiments, the one or more narrow-band absorbers exhibit a FWHM from about 0.5 nm to about 100 nm.

Thus, according to the invention, a display system such as a projector system is provided that comprises a projector and a light-absorbing substrate that contains narrow-band absorbers designed to selectively absorb the wavelengths emitted by the projector. The projector projects or emits light toward a viewing surface that allows viewing of the image by both an intended viewer and an unintended viewer. The light absorbing substrate is positioned between the viewing surface and the unintended viewer, such that the image perceived by the unintended viewer is reduced or eliminated.

In one aspect as used herein, a “display system” includes a projector or light emitter, a viewing surface, and a light-absorbing substrate. An image or images may be generated, for example by a computerized signal generator, and fed to the projector, which generates light patterns toward the viewing surface such that an image is formed, the viewing surface allowing viewing of the image by both an intended viewer and an unintended viewer. As further described herein, the type of projector is not especially limited, and may be any of the following: a laser diode-based projector, a DPSS laser-based projector, an LED projector, a hybrid laser-LED projector, or a wave guide projector, or the like.

As used herein, the “intended viewer” is the viewer for whom the projected image is intended or desired to be viewed. This may be a viewer who herself desires to view the image, or someone for whom the image is intended to be viewed who may not himself strongly desire to view the content, but for whom the image is nonetheless intended to be viewed by him, for example his teacher. The intended viewer is thus a viewer that someone intends to view the image, whether or not the viewer himself.

Likewise, the “unintended viewer” is a viewer positioned so as to be able to see the viewing surface, but for whom the image is not intended or not desired to be seen. This could be someone “eavesdropping” from an adjacent room who should be doing something other than viewing an image the unintended viewer was not intended to be viewing, for example a student in another class, or in study hall, or in detention. Alternatively, the unintended viewer may himself not want to see the image, for example someone who would prefer not to be distracted by the image, even though he is positioned so as to be able to see the image. The unintended viewer is thus a viewer that someone intends not to view the image, whether or not it is the viewer himself who does not desire or intend to see it.

According to the invention, then, the light-absorbing substrate may be a window film placed on a window or may be any other transparent light-absorbing substrate placed between the viewing surface and the unintended viewer. Alternatively, the light-absorbing substrate may comprise lenses in an eyeglass frame that the unintended viewer may wear.

The term “viewing surface” is not intended to be limited, but rather is intended to refer to any surface which an image may be projected onto, into, or through the viewing surface such that the image from the projector may be viewed by a viewer, from one or both sides. For example, the viewing surface may be a traditional opaque projector screen onto which the projector projects the image. Alternatively, the viewing surface may be translucent or transparent, and the image may be projected from behind the viewing surface, the intended viewer thus being located “in front of” the viewing surface. The viewing surface may be further provided with other images not projected by the projector, for example other images that may be perceived by the unintended viewer even when the images from the projector have been blocked or reduced by the light-absorbing substrate.

As used herein, the “image” or “primary image” thus refers to the projected image that is reflected off or transmitted through the viewing surface in the direction of the intended viewer. This primary image is an intended image which is reflected from or transmitted through the viewing surface and travels to the intended viewer in the form of visual information.

As used herein, the image, especially as seen by an unintended viewer, may be a “reverse image,” for example if the unintended viewer is on a side of the viewing surface opposite the intended viewer. Thus, instead of being viewed from the “front,” that is, from the viewpoint of the intended viewer, the reverse image is instead viewed from the other side of the viewing surface, thus being reversed.

The light-absorbing substrate of the invention thus incorporates narrow-band absorbers selected to absorb light of the same or similar wavelengths in the visible spectrum as those emitted by a projector or emitter. Typical projectors emit or project light at three narrow wavelengths representing the three primary colors of red, green, and blue, using the RGB additive color model. These typically correspond, for example, to approximately 580-700 nm (red), 480 nm to 580(green), and 400-480 nm (blue). In a more specific embodiment, the wavelength ranges in the RGB model may be considered to be 600-700 nm (red), 500-560 nm (green), and 400-490 nm (blue). Alternatively, we may consider these ranges to be 635-700 nm (red), 520-560 nm (green), and 400-450 nm (blue), or as described elsewhere herein. The three-color combination enables the production of a nearly infinite set of projected colors in the final image. The narrow breadth of each color or wavelength range is designed to minimize effects to the bulk of the light passing to or through the viewing surface. The light-absorbing substrate according to the invention is provided with similarly-matched narrow wavelength absorbers such that the image perceived by the unintended viewer is reduced or eliminated.

As used herein, the terms “projector,” “emitter,” and “light emitter” are used to describe elements that emit or project light, and especially multiple selected wavelength ranges, for example at least two discrete wavelength ranges, or three discrete wavelength ranges, or at least three discrete wavelength ranges.

When only two discrete wavelength ranges are used, the wavelength ranges will be those of the red and the blue as further described herein.

In one aspect, the projector may be an LED projector. LED projectors typically use 2 or 3 individual LEDs to produce a more narrow spectrum of light that can be combined to form white light or any color combination. 2-LED systems produce green by shifting the blue LED, resulting in a broad green emission. 3-LED systems use separate RGB LEDs. However, the typical LED peak width (typically 15-30 nm) may still be too broad for certain aspects of the invention. A laser projector may therefore be preferred in certain applications.

In another aspect, the projector is thus a laser projector. Laser projectors use lasers to create RGB image components that can be combined to produce white light or any color combination. Lasers typically have extremely narrow emission spectra (typically ˜2 nm), making them especially suitable for use according to the invention.

In one aspect, then, the projector may be a laser diode-based projector, for example, that is capable of emitting center wavelengths of 445 nm (blue), 515 or 520 (green), and 642 nm, 635 nm, 638 nm, 650 nm, or 660 nm (red). We note that when only two discrete wavelength ranges are provided by the projector, the wavelength ranges will be those of the red and the blue as further described herein.

In another aspect, the projector may be, for example a DPSS laser-based projector with center wavelengths of 457 or 473 nm, 532, and 671 nm. Laser projectors are considered to give the best image quality and color reproduction compared to lamp and LED type projectors.

As used herein, the discrete wavelength ranges of light projected by the projector, and likewise the discrete wavelength ranges of light absorbed by the narrow band absorbers, may have defined widths, reported herein as FWHM, or full-width half-maximum values, that is, the wavelength range at which half of the maximum intensity of the light projected or emitted is achieved, as calculated by I2−I1, where I1 and I2 are the wavelengths nearest the respective peak wavelength where the measured light intensity is half of the peak intensity, and I2>I1.

Thus according to the invention, these discrete wavelength ranges may have a width (FWHM) of at least 0.5 nm, or at least 1 nm, or at least 2 nm, or at least 5 nm, and up to about 5 nm, or up to 7 nm, or up to 10 nm, or up to 15 nm, or up to 20 nm, or up to 25 nm, or up to 30 nm, or up to 50 nm, or up to 100 nm.

The light-absorbing substrate may be any substrate in which or on which the narrow-band absorbers may be placed. The light-absorbing substrate can be a monolayer, or multilayer, and can incorporate multiple other functionalities, as known to those skilled in the art.

For example, in one aspect the light-absorbing substrate is a transparent polymer. In another aspect, the light absorbing substrate is a polymer film such as a window film applied to a transparent substrate such as glass. In another aspect, the light-absorbing substrate is disposed on a transparent substrate, for example by coating a light-absorbing substrate onto the transparent substrate. In yet another aspect, the light absorbing substrate is disposed between two rigid substrates, for example a PVB interlayer between two panes of glass. In another aspect, the light-absorbing substrate comprises eyeglass lenses, or is applied to eyeglass lenses, of the unintended viewer. The light-absorbing substrate may thus be any transparent substrate positioned between the viewing surface and the unintended viewer so as to absorb light such that the image perceived by the unintended viewer is reduced or eliminated.

According to the invention, the light-absorbing substrate is provided with narrow-band absorbers, which may be any molecule, compound, or particle that absorbs light in the desired wavelength range. These would typically be absorbing dyes but could also comprise absorbing pigments. Different narrow band absorbers will likely be employed to absorb at the peak wavelength for each of the projector colors employed. The molecules are ideally incorporated at concentrations that will absorb>50% of the light at each of the peak color wavelengths, or at least 55%, or at least 65%, or at least 75% of the light at each of the peak color wavelengths. In the case of pigments, it is understood that particle size would be minimized to reduce unwanted haze.

By aligning the absorbers with the projector emission, we can effectively absorb light that would otherwise arrive at the unintended viewer's eyes as an image, such that the image perceived by the unintended viewer is reduced or eliminated.

In a preferred aspect, the narrow-band absorbers comprise dyes or pigments that selectively absorb light in discrete wavelength ranges, typically corresponding, for example, to approximately 625-740 nm (red), 500 nm to 565 nm(green), and 430-490 nm (blue).

Thus, when dyes or pigments are used as narrow-band absorbers, the absorption peak, or Imax of the dye or pigment, should be aligned as closely as practicable with the projector emission wavelengths, e.g. 443, 524, 643 nm. Projectors with different wavelengths can also be employed, provided a balanced RGB output can be achieved to provide a normal color balance. The absorption peak width (FWHM) should be as narrow as possible to achieve sufficient absorption of the desired projector emission wavelengths, with a minimum impact on visible transmission. FWHM should thus desirably be less than 50 nm, or less than 30 nm. Failing to meet this requirement will either result in low contrast ratio or low Tvis Absorbers should have no, or limited, secondary absorption peaks or shoulders. When placed in a PVB substrate, the absorbers should be soluble in plasticizer in an amount, for example, from about 30 ppm to about 750 ppm, in order to compound into PVB or into a solvent for coating, typically in even higher concentrations are often typical or desired to minimize the coating thickness. Concentrations outside of this range may be possible as well. For use in PVB or coatings, absorbers should have sufficient thermal stability; a minimum of 200° C. for extrusion or 150° C. for coating/autoclave lamination. Absorbers should also have sufficient UV stability to survive outdoor exposure in a windscreen for >5 years, when a windscreen is intended. The light-absorbing substrate may also incorporate an ultra-violet (UV) blocker; the UV blocker has negligible effect in the visible range. The UV blocker may be a dye that is disposed in or onto the polymer substrate. The UV dye absorber may be coated on the outer surface of the polymer substrate to reduce the exposure of the narrow band absorbers and increase the UV stability of the system. Examples of UV absorber dyes are Maxgard and Cyasorb UV stabilizers. The light absorbing substrate may also incorporate NIR absorbers in amounts that have limited effect on the overall VLT. The NIR absorbers will provide reduction of NIR solar radiation if desired.

In one aspect, the narrow-band absorbers comprise pigments. Pigments are differentiated from dyes in that their solubility characteristics in the medium are significantly reduced and are generally considered to be insoluble in the medium. Pigments are comprised of two general classes of molecules, organic and inorganic. Examples of suitable inorganic pigments include compounds or complexes of aluminum, copper, cobalt, manganese, gold, iron, calcium, argon, bismuth, lead, titanium, tin, zinc, mercury, antimony, barium or combinations thereof, including silicates, oxides, phosphates, carbonates, sulfates, sulfides, and hydroxides. (Völz, Hans G.; et al. “Pigments, Inorganic”. Ullmann's Encyclopedia of Industrial Chemistry. Weinheim: Wiley-VCH. doi:10.1002/14356007.a20_243.pub2 \hat{ }Müller, Hugo; Müller, Wolfgang; Wehner, Manfred; Liewald, Heike. “Artists' Colors”. Ullmann's Encyclopedia of Industrial Chemistry. Weinheim: Wiley-VCH. doi:10.1002/14356007.a03_143.pub2.)

Examples of suitable organic pigments include the same chemical classes as described herein for dyes, with differentiated solubility imparted by suitable substituents, most commonly based on aromatic hydrocarbons. When pigments are used as the narrow-band absorbers, they may be present in amounts from about 0.001% to about 50%, or from 0.001% to 25%, or from 0.001% to 10%, or from 0.001 to 1%, or from 0.001% to 0.1%.

The particle size of the pigments may be important, in order to achieve the desired optical quality. Particle size and shape affect both color strength and scattering, which directly impact overall optical quality as well as haze and clarity. Larger particle size and aspect ratio may decrease color strength and increase or decrease scattering, improving haze and, conversely, smaller particle size and aspect ratio increase color strength, and increase or decrease scattering, decreasing haze. Thus, the average particle size of the pigments may be from about 10 nm to about 500 micron, or from 100 nm to 100 micron.

In one aspect, the haze caused by the pigments will be less than 5%, 2%, 1.5%, 1%, or 0.5%, as measured by a haze-meter such as the Haze-guard from BYK-Gardner Instruments, according to ASTM D-1003.

In another aspect, the narrow-band absorbers comprise dyes. Dyes suitable for use according to the invention typically possess color because they absorb light in the visible spectrum (about 400 to about 700 nm), have at least one chromophore (colour-bearing group), have a conjugated system, that is, a structure with alternating double and single bonds, and exhibit resonance of electrons, a stabilizing force in organic compounds. Most dyes also contain groups known as auxochromes (color helpers), examples of which are carboxylic acid, sulfonic acid, amino, and hydroxyl groups. While these are not responsible for color, their presence can shift the color of a colorant and may be used to influence dye solubility.

According to the invention, the display systems comprise one or more narrow band absorbers, that collectively absorb light selectively within three wavelength ranges in the visible spectrum. Thus, a single narrow band absorber may absorb light in more than one wavelength range. The narrow band absorber may have more than one absorption peak, each absorption peak absorbing light in a different wavelength range. Careful selection or design of the narrow band absorber may provide more than one absorption peak, each aligned with a different wavelength range. The narrow band absorber may contain more than one chromophore, the part of the molecule responsible for absorption in the visible range of the electromagnetic spectrum. The narrow band absorber may also comprise more than one dye or pigment that are covalently bonded together to provide one chemical structure having more than one absorption peak, each aligned with a different projector wavelength range.

One class of suitable dyes are polymethine dyes. Polymethine dyes are molecules whose chromophoric system consists of conjugated double bonds (polyenes), where n is uneven, e.g., 1, 3, 5, 7, etc., flanked by two end groups, X and X′. X and X′ are most commonly O or N derivatives and are categorized into subclasses.

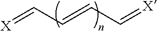

Subclasses can be defined as:

| | |
|---|---|
| X = X′ | Polymethine dyes |
| X = X′ = N | Cyanine dyes |
| X = X′ = O | Oxonole dyes |
| X ≠ X′ | Meropolymethine dyes |
| X = N, X′ = O | Merocyanine dyes |

A special case is zwitterionic polymethine dyes, an example shown here:

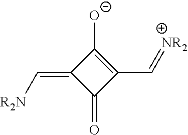

These conjugated systems have the ability to be stabilized through delocalized electronic states and can be tuned with different functional groups as substituents to change the electronic absorption properties of their UV spectrum. As a result, they can exist as neutral molecules or salts (charged species paired with a counter ion). The charged nitrogen in these molecules can exist in a neutral state or as a positively charged group, for example as an iminium ion paired with an anion. Examples or subclasses of polymethine dyes include cyanine dyes, hemicyanine dyes, streptocyanine dyes, merocyanine dyes, oxonol dyes, porphyrin dyes, tetraazaporphyrin dyes, phthalocyanine dyes, styryl dyes, di- and triarylmethine dyes, squaraine dyes, squarate dyes, and croconate polymethine dyes. Polymethine dyes are generally α,ω-substituted odd polyenes). The dyes can be functionalized in innumerable ways to derive differentiated absorption peaks and widths. Examples of groups used to functionalize dyes include linear aliphatic, cycloaliphatic, aromatic, and heteroaromatic moieties and combinations thereof. Porphyrin dyes, tetraazaporphyrin dyes and phthalocyanine dyes can form complexes with metals to derive differentiated absorption peaks and widths as well. Examples of metals that may form complexes with porphyrin dyes, tetraazaporphyrin dyes and phthalocyanine dyes include transition metals, post-transition metals, alkaline earth metals and alkali metals. In some cases, the metal complexes may contain metal oxides or the metal complexes may contain a halide.

Examples of dyes that may selectively absorb light at wavelength ranges from approximately 625-740 nm (red) include N-(4-((4-(Dimethylamino)phenyl)(3-methoxyphenyl)methylene)-cyclohexa-2,5-dien-1-ylidene)-N-methylmethanaminium (Epolin 5262), Epolin 5394, Epolin 5839, Epolin 6661, Exciton ABS626, Exciton ABS642, Cyclobutenediylium, 1,3-bis[(1,3-dihydro-3,3-dimethyl-1-propyl-2H-indol-2ylidene)methyl]-2,4-dihydroxy-, bis (inner salt) (QCR Solutions Corp VIS630A), QCR Solutions Corp VIS637A, QCR Solutions Corp VIS641A, QCR Solutions Corp VIS643A, QCR Solutions Corp VIS644A, QCR Solutions Corp VIS651B, QCR Solutions Corp VIS 654C.

Examples of dyes that may selectively absorb light at wavelength ranges from approximately 500 nm to approximately 565 nm (green) include Epolin 5396, Epolin 5838, 3-pyridinecarbonitrile, 1-butyl-5-[2-(1,3-dihydro-1,3,3-trimethyl-2H-indol-2-ylidene)ethylidene]-1,2,5,6-tetrahydro-4-methyl-2,6-dioxo-(QCR Solutions Corp VIS518A), QCR Solutions Corp VIS523A, QCR Solutions Corp VIS542A.

Examples of dyes that may selectively absorb light at wavelength ranges from approximately 430 to 485 nm (blue) include Propanedinitrile, 2-[[4-[[2-(4-cyclohexylphenoxy)ethyl]ethylamno]-2-methylphenyl]methylene]-(Epolin 5843), Epolin 5852, Epolin 5853, Epolin 5854, Exciton ABS433, Exciton ABS439, Exciton ABS454, QCR Solutions Corp VIS441A.

Examples of dyes suitable for use according to the invention thus include:
Epolin 5262: CAS Registry Number 42297-44-9, N-(4-((4-(Dimethylamino)phenyl)(3-methoxyphenyl)methylene)-cyclohexa-2,5-dien-1-ylidene)-N-methylmethanaminium

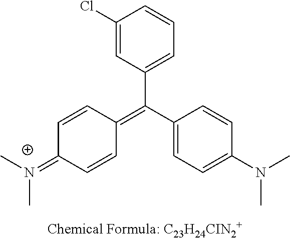

Epolin 5843, CAS Registry number 54079-53-7, Propanedinitrile, 2-[[4-[[2-(4-cyclohexylphenoxy)ethyl]ethylamno]-2-methylphenyl]methylene]—

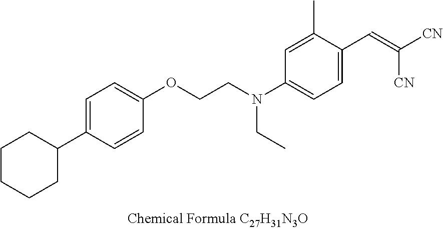 [SMILES: CCN(CCOc1ccc(C2CCCCC2)cc1)c1ccc(C=C(C#N)C#N)c(C)c1]

QCR VIS518A, CAS Registry Number: 201420-04-4, 3-pyridinecarbonitrile, 1-butyl-5-[2-(1,3-dihydro-1,3,3-trimethyl-2H-indol-2-ylidene)ethylidene]-1,2,5,6-tetrahydro-4-methyl-2,6-dioxo-

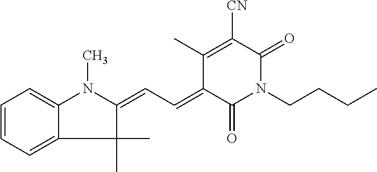 [SMILES: CCCCN1C(=O)C(C#N)=C(C)/C(=C\C=C2\N(C)c3ccccc3C2(C)C)C1=O]

QCR VIS630A, CAS Registry Number: 201557-75-5, Cyclobutenediylium, 1,3-bis[(1,3-dihydro-3,3-dimethyl-1-propyl-2H-indol-2ylidene)methyl]-2,4-dihydroxy-, bis (Inner Salt)

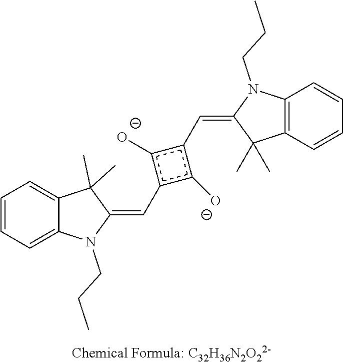

Other dyes suitable for use according to the invention include those disclosed in JP6674174 B2, both methine dyes and metal complex structures, the disclosure of which is incorporated herein by reference. Thus, in this aspect, a metal complex compound represented by the formula (1) may be used:

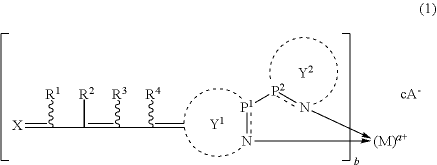

where R1 to R4 are each independently a substituted/unsubstituted alkyl group or the like, X is a monocyclic or polycyclic heterocyclic group or the like, a ring Y1 and a ring Y2 are each independently monocyclic or polycyclic heterocycle, P1 and P2 are each independently C or N, M is Group 3 to Group 12 atom, the arrow is a coordinate bond, a to c are integers of 1 to 3, A is a halide ion or an anion compound such as BF4—.

Metal complex dyes are thus also suitable for use according to the invention. Metal-complex dyes may be broadly divided into two classes: 1:1 metal complexes and 1:2 metal complexes. The dye molecule will be typically a monoazo structure containing additional groups such as hydroxyl, carboxyl or amino groups, which are capable of forming strong coordination complexes with transition metal ions. Typically, chromium, cobalt, nickel and copper are used.

Azo dyes are also suitable for use according to the invention. The most prevalent metal complex dyes for textile and related applications are metal complex azo dyes. They may be 1:1 dye:metal complexes or 2:1 complexes and contain mainly one (monoazo) or two (disazo) azo groups.

Other dyes suitable for use according to the invention include those disclosed in JP6417633, the disclosure of which is incorporated herein by reference. Thus, azo dyes may be used which are tetraazaporphyrin compounds which are mixtures of 4 kinds of isomers obtained by heat cyclization reaction of a metal or a metal derivative with a cis body of 1,2-dicyanoethylene compound represented by the following formula 1:

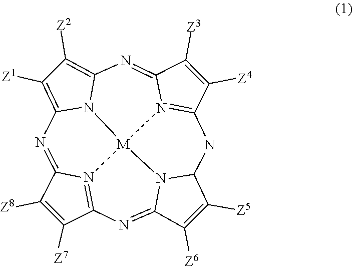

In which one of two substitutions Z1 and Z2 is a cyclic alkyl group which may have a substituent and the other is an aryl group which may have a substituent.

Others include those metal complex dyes disclosed in WO201004833, the disclosure of which is incorporated herein by reference.

Others include those disclosed in JP2007211226, which discloses a coloring matter for use in an optical filter which is said to be excellent in durability, capable of cutting a light having unnecessary wavelengths existing in 540-600 nm in order to clear the contrast of an image, and capable of preventing the mirroring and reflection of a light of 540-560 nm from an external light such as a fluorescent lamp, in order to maintain the distinctness of an indicated image. The compounds disclosed are rhodamine-based compounds expressed by the general formula (1):

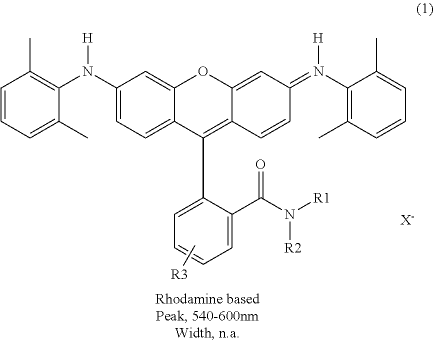

wherein, R1 and R2 are each an aryl group having no substituent or a substituent selected from a methyl group and the like and a halogen and having the number of nuclear carbons of 6-24; R3 is a hydrogen atom, a methyl group or a halogen; and X(sup−) is a counter ion). Xanthene dyes, rhodamine dyes, fluorescein dyes and substituted versions of these dyes are also useful dyes according to the invention.

Other dyes useful according to the invention include carbocyclic azo dyes, heterocyclic azo dyes, indole-based dyes, pyrazolone based eyes, Pyridone based dyes, Azopyrazolone based dyes, S or S/N heterocyclic, metallized azo dyes, Anthraquinone based dyes, Indigoid based dyes, Cationic dyes, Di- and triarylcarbenium dyes, Phthalocyanine dyes, Sulfur Dyes, Metal complexes as dyes, Quinophthalone Dyes, Nitro and Nitroso dyes, Stilbene dyes, Formazan dyes, Triphenodioxazines, Benzodifuranones.

Some dyes useful according to the invention may be proprietary, that is, the actual chemical structure of the dye may not be known. Those skilled in the art of dye preparation and selection can select a suitable dye for use according to the invention based on its particular absorption spectrum, which is typically available from the vendor even when the identity of the molecule itself is not disclosed. Those skilled in the art of compounding, for example PVB interlayers, will understand that a dye, when present in the PVB itself, must survive the processing parameters, which include time at relatively high temperatures, in the presence of plasticizers that might degrade the dye.

When used in PVB interlayers, the narrow-band absorbers should be soluble or dispersible in plasticizer (˜30-300 ppm) to compound into PVB or into some solvent for coating (at higher concentration). In this aspect, the absorbers should have sufficient thermal stability, for example a minimum 200° C. for extrusion or 150° C. for coating/autoclave lamination. Further, the absorbers should have sufficient UV stability for the intended use, for example to survive outdoor exposure in a windscreen for >5 years.

Ideally, the dyes useful according to the invention will exhibit absorption peaks (Iₘₐₓ) that are aligned with the projector emission wavelength ranges, e.g. 443 nm, 524 nm, and 643 nm. As noted, projectors with different wavelengths may also be employed, so long as a balanced RGB output can be achieved to provide a desired color balance. The absorption peak width (as characterized by the Full Width at Half Maximum or FWHM) of the dye should also be as narrow as possible to achieve sufficient absorption of the desired projector wavelengths with a minimum impact on visible transmission. Thus, the FWHM of the dyes may be, for example, less than 10 nm, or less than 20 nm, or less than 30 nm, or less than 40 nm, or less than 50 nm, or less than 60 nm. If the wavelength range at which the dyes absorb light is too broad, it will be difficult to achieve the desired contrast ratio and/or Tvis values. We note that the FWHM of each of the dyes may not need to be the same; it need to just be sufficient to make the unintended view not legible.

Ideally, the narrow-band absorbers will have no or limited secondary absorption peaks or shoulders.

Dye Absorptivity: How strongly a dye absorbs, known as its absorptivity, does not necessarily impact its performance according to the invention. It is, however, a factor in determining the amount of dye that is required to be incorporated in or on the light absorbing substrate. If the absorptivity of a dye, ε, is known, the Beer-Lambert Law, A=εcl, can be used to calculate the concentration of dye needed, c, to achieve the desired level of absorption, A, from a given light absorbing substrate with thickness l. The amount of dyes required should be sufficient to substantially reduce the emission of the projection after it is reflected from the viewing screen. Dye absorptivities useful according to the invention may range, for example, from 10 to 1000, or from 20 to 800, or from 60 to 700 L/g/cm.

While the composition of the present invention has been described above in detail, it will be understood by the person of ordinary skill that the composition of the present invention may be utilized in a wide variety of end-use applications.

The following examples set forth suitable and/or preferred methods and results in accordance with the invention. It is to be understood, however, that these examples are provided by way of illustration and nothing therein should be taken as a limitation upon the overall scope of the invention. All percentages are by weight unless otherwise specified.

### Example 1. (Prophetic)

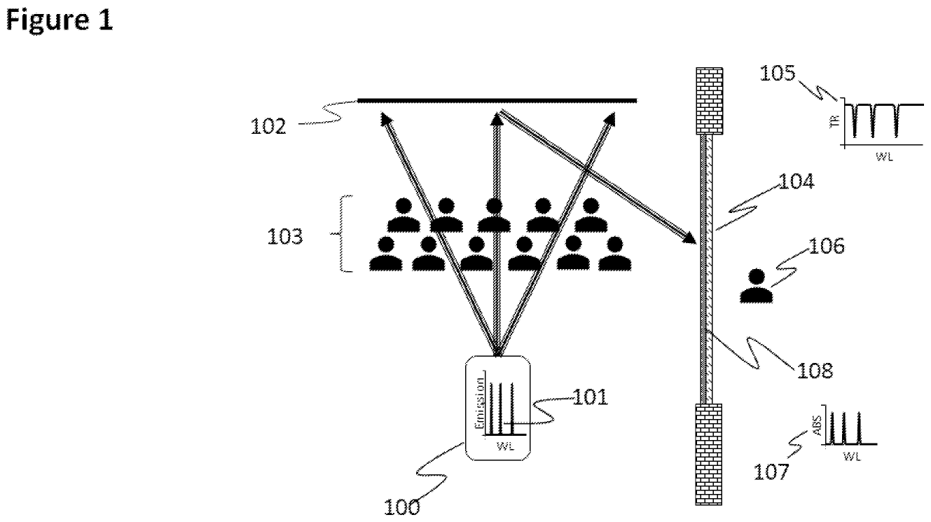

A laser projector (100) is provided in a projection room, according to FIG. 1, containing intended viewers (103), and the laser projector (100) emits light at wavelength ranges of 443 nm, 524 nm, and 643 nm (101), each of which ranges have a width less than about 2 nm, as defined by FWHM. The projector (100) is oriented to emit light toward a projection screen (102), creating an image in the form of an adventure movie that the one or more intended viewers intend to watch. Another room is adjacent the projection room, and has an unintended viewer (106) who is supposed be doing something other than watching adventure movies. The unintended viewer is positioned so that she can see the projection screen in the projection room through a window (104). The window has a light-absorbing substrate (108) applied to it in the form of a window film that contains three dyes, Dye R, Dye G, and Dye B (107).

Dye R absorbs light centered at about 643 nm, and has a FWHM of about 30 nm, and an absorptivity of about 90 L/g/cm, and is thus provided in the window film in an amount of about 140 ppm.

Dye G absorbs light centered at about 523 nm, and has a FWHM of about 25 nm, and an absorptivity of about 60 L/g/cm, and is thus provided in the window film in an amount of about 250 ppm.

Dye B absorbs light centered at about 443 nm, and has a FWHM of about 28 nm, and an absorptivity of about 160 L/g/cm, and is thus provided in the window film in an amount of about 75 ppm.

When the projector (100) projects light in the form of an image onto the projector screen (102), the image perceived through the light-absorbing substrate by the unintended viewers (106) is barely discernible when compared with the display system in which the light-absorbing substrate is not provided with the three dyes, due to absorption (107) in the wavelength ranges of interest, thus discouraging the unintended viewer from viewing the adventure movie when she should be doing her homework.

### Example 2. (Prophetic)

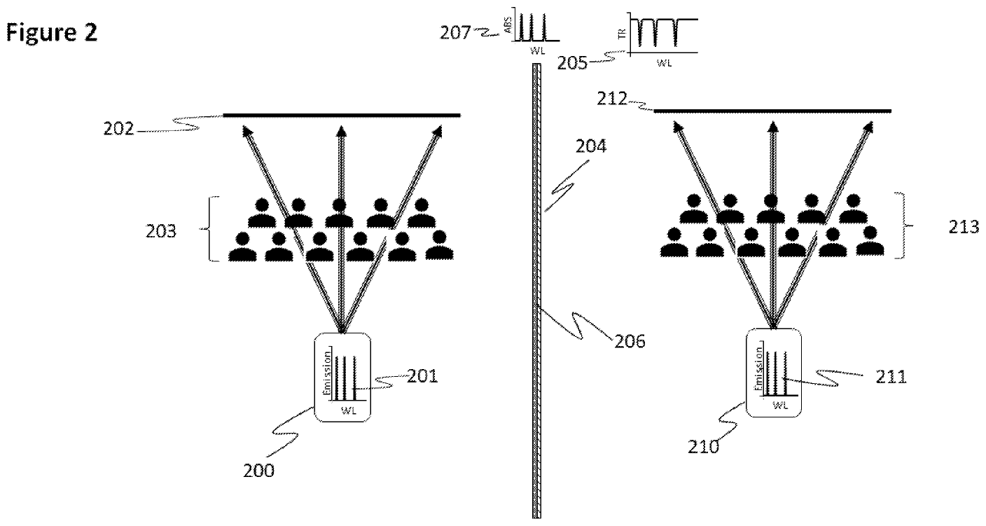

Turning now to FIG. 2, two adjacent areas are depicted separated by a window (204) having a light-absorbing substrate (206) applied to it in the form of a window film that contains the three dyes, Dye R, Dye G, and Dye B (207) of Example 1. A laser projector (200) and (210) is provided in each of the respective areas, according to FIG. 2, each of which areas contains intended viewers (203) and (213), with respect to the projector in their area, and unintended viewers with respect to the projector in the adjacent area. That is, viewers (213) are unintended viewers with respect to projector (200) and intended viewers with respect to projector (210). Similarly, viewers (203) are unintended viewers with respect to projector (210) and intended viewers with respect to projector (200).

The laser projectors (200) and (210) emit light at wavelength ranges of 443 nm, 524 nm, and 643 nm (205), each of which ranges have a width less than about 2 nm, as defined by FWHM. The projector (200) is oriented to emit light toward a projection screen (202), creating an image in the form of an adventure movie that the one or more intended viewers intend to watch. However, the projector (210) is oriented to emit light toward a projection screen (212), creating an image in the form of a remedial calculus lecture for those who failed their last test. Because of the light-absorbing substrate (206) window film applied to the window (204), the calculus students cannot see the adventure movie projected on screen 202, and those watching the adventure movie are not distracted by the calculus lecture depicted on screen (212).

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A display system for displaying an image, the display system comprising:
a. a projector that emits light toward a viewing surface at three discrete wavelength ranges in the visible spectrum to create an image;
b. a viewing surface that allows viewing of the image by both an intended viewer and an unintended viewer; and
c. a light-absorbing substrate, disposed between the viewing surface and the unintended viewer, incorporating one or more narrow-band absorbers that selectively absorb light within the three discrete wavelength ranges, thus reducing or eliminating the image perceived by the unintended viewer.

2. The display system of claim 1, wherein the three discrete wavelength ranges emitted by the projector include light of 445 nm, 515 nm, and 642 nm.

3. The display system of claim 1, wherein the three discrete wavelength ranges emitted by the projector include light of 445 nm, 550 nm, and 642 nm.

4. The display system of am claim 1, wherein one of the discrete wavelength ranges emitted by the projector includes light having a wavelength selected from one or more of 635, 638, 650, or 660.

5. The display system of claim 1, wherein the one or more narrow band absorbers exhibit a FWHM from about 0.5 nm to about 100 nm.

6. The display system of claim 1, wherein at least one of the three wavelength ranges of light emitted by the projector exhibits a FWHM from about 0.5 nm to about 100 nm.

7. The display system of claim 1, wherein the projector is selected from a laser diode-based projector, a DPSS laser-based projector, an LED projector, a hybrid laser-LED projector, or a wave guide projector.

8. The display system of claim 1, wherein the narrow-band absorbers are selected from dyes and pigments.

9. The display system of claim 1, wherein at least one of the narrow-band absorbers is a polymethine dye.

10. The display system of am claim 1, wherein the light absorbing substrate comprises a window.

11. The display system of am claim 1, wherein the window comprises a transparent polymeric substrate.

12. The display system of claim 1, wherein the light absorbing substrate is a window film applied to a window.

13. The display system of claim 1, wherein the light absorbing substrate comprises a pair of eyeglass lenses worn by the unintended viewer.

14. The display system of claim 1, wherein the light absorbing substrate further comprises a UV absorber.

15. The display system of claim 1, wherein the light-absorbing substrate further comprises a near infrared absorber.

16. A method of preventing unintended viewing of an image on a viewing surface, the image formed from light from a projector emitted at three discrete wavelength ranges, the method comprising placing a light-absorbing substrate between the viewing surface and the unintended viewer, that incorporates one or more narrow-band absorbers that selectively absorb light within the three discrete wavelength ranges, thus reducing or eliminating the image perceived by the unintended viewer.

17. The method of claim 16, wherein the three discrete wavelength ranges emitted by the projector include light of 445 nm, 515 nm, and 642 nm.

18. The method of claim 16, wherein the three discrete wavelength ranges emitted by the projector include light of 445 nm, 550 nm, and 642 nm.

19. The method of claim 16, wherein one of the discrete wavelength ranges emitted by the projector includes light having a wavelength selected from one or more of 635, 638, 650, or 660.

20. The method of claim 16, wherein the projector is selected from a laser diode-based projector, a DPSS laser-based projector, an LED projector, a hybrid laser-LED projector, or a wave guide projector.

21. The method of claim 16, wherein the narrow-band absorbers are selected from dyes and pigments.

22. The method of am claim 16, wherein the one or more narrow-band absorbers exhibit a FWHM from about 0.5 nm to about 100 nm.

23. The method of am claim 16, wherein at least one of the three wavelength ranges of light emitted by the projector exhibits a FWHM from about 0.5 nm to about 100 nm.
